(19) United States
(12) Patent Application Publication
(10) Pub. No.: US 2016/0027393 A1
(43) Pub. Date: Jan. 28, 2016

(54) ACTIVE MATRIX LIQUID CRYSTAL DISPLAY, ELECTRONIC DEVICE, AND DRIVING METHOD THEREOF

(71) Applicant: InnoLux Corporation, Miao-Li County (TW)

(72) Inventor: Masahiro Yoshiga, Miao-Li County (TW)

(21) Appl. No.: 14/340,826

(22) Filed: Jul. 25, 2014

(51) Int. Cl. G09G 3/36

(52) U.S. Cl. CPC G09G 3/3648; G09G 2310/06

(57) ABSTRACT

An active matrix liquid crystal display including: a plurality of pixel cells, each of which is formed by a pair of electrodes sandwiching a liquid crystal layer, wherein when the active matrix liquid crystal display is displaying a static image, the pixel cell is refreshed through a first period, a second period, and a third period in sequence, wherein in the first period, the pixel cell is charged by at least a non-target voltage; in the second period, the pixel cell is charged by a target voltage; and in the third period, the pixel cell is not charged until the next first period.

### BACKGROUND OF THE INVENTION

1. Field of the Invention

The present invention relates to an active matrix liquid crystal display, an electronic device, and a driving method thereof, and in particular to an active matrix liquid crystal display, an electronic device, and a driving method capable of reducing the flicker when a low frequency driving scheme is applied to a display when displaying a static image.

2. Description of the Related Art

When an active matrix liquid crystal display is displaying a static image, it is preferable for the static image not to be refreshed as many times as a dynamic image, in order to save power. Given this concern, a low frequency driving scheme is usually applied to the liquid crystal display to refresh a static image. For example, the liquid crystal display is driven at 10 Hz when a static image is displayed. In other words, in every 6 frames, the liquid crystal display is only driven during a frame and not driven during the rest 5 frames. Therefore, some driving ICs stop functioning for the duration of 5 frames, which lowers power consumption.

However, under a low frequency driving scheme, every time the pixel cell is refreshed, a visible flicker is generated, detracting from the image quality. The flicker is more obvious in low to middle gray levels, and especially in dark gray levels.

In view of this problem, the purpose of the present invention is to provide a new low frequency driving scheme which can reduce the flicker.

### BRIEF SUMMARY OF THE INVENTION

A detailed description is given in the following embodiments with reference to the accompanying drawings.

The invention provides an active matrix liquid crystal display, including a plurality of pixel cells, each of which is formed by a pair of electrodes sandwiching a liquid crystal layer. When the active matrix liquid crystal display is displaying a static image, the pixel cell is refreshed through a first period, a second period, and a third period in sequence. In the first period, the pixel cell is charged by at least a non-target voltage. In the second period, the pixel cell is charged by a target voltage. In the third period, the pixel cell is not charged until the next first period.

In the active matrix liquid crystal display, the first period lasts for at least one frame, the second period lasts for a frame, and the third period lasts for a plurality of frames.

In the active matrix liquid crystal display, the non-target voltage is determined according to the target voltage, and each target voltage corresponds to a distinct non-target voltage.

In the active matrix liquid crystal display, the target voltages in any two adjacent second periods have opposite polarities.

In the active matrix liquid crystal display, the target voltage is a gray level voltage which is applied to the pixel cell to output a gray level to be displayed.

The invention also provides a driving method for an active matrix liquid crystal display including a plurality of pixel cells, each of which is formed by a pair of electrodes sandwiching a liquid crystal layer. The driving method includes charging the pixel cell with at least a non-target voltage in a first period; charging the pixel cell with a target voltage in a second period following the first period; and stopping the charging of the pixel cell in a third period following the second period, wherein the first to third periods are repeated to continuously refresh a static image.

In the driving method, the first period lasts for at least one frame, the second period lasts for a frame, and the third period lasts for a plurality of frames.

In the driving method, the non-target voltage is determined according to the target voltage, and each target voltage corresponds to a distinct non-target voltage.

In the driving method, the target voltages in any two adjacent second periods have opposite polarities.

In the driving method, the target voltage is a gray level voltage which is applied on the pixel cell to output a desired level to be displayed.

According to the active matrix liquid crystal display, electronic device or driving method, when the active matrix liquid crystal display is displaying a static image by a low frequency driving scheme, visible flicker is reduced and the image quality is improved.

### BRIEF DESCRIPTION OF THE DRAWINGS

The present invention can be more fully understood by reading the subsequent detailed description and examples with references made to the accompanying drawings, wherein:

FIG. 1 is a diagram showing a conventional low frequency driving scheme with column inversion;

FIG. 2 is a diagram showing the pixel voltage change during the refresh period under the low frequency driving scheme shown in FIG. 1;

FIG. 3 is a diagram showing the voltage change across the pixel cell during the refresh period under the low frequency driving scheme shown in FIG. 1;

FIG. 4 is a diagram showing the light intensity change during the refresh period under the low frequency driving scheme shown in FIG. 1;

FIG. 5 is a diagram showing the average curve of the light intensity during the refresh period under the low frequency driving scheme shown in FIG. 1;

FIG. 6 is a diagram showing a low frequency driving scheme with column inversion in accordance with an embodiment of the invention;

FIG. 7 is a diagram showing the pixel voltage change during the refresh period under the low frequency driving scheme shown in FIG. 6; and

FIG. 8 is a diagram showing the average curve of the light intensity during the refresh period under the low frequency driving scheme shown in FIG. 6.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

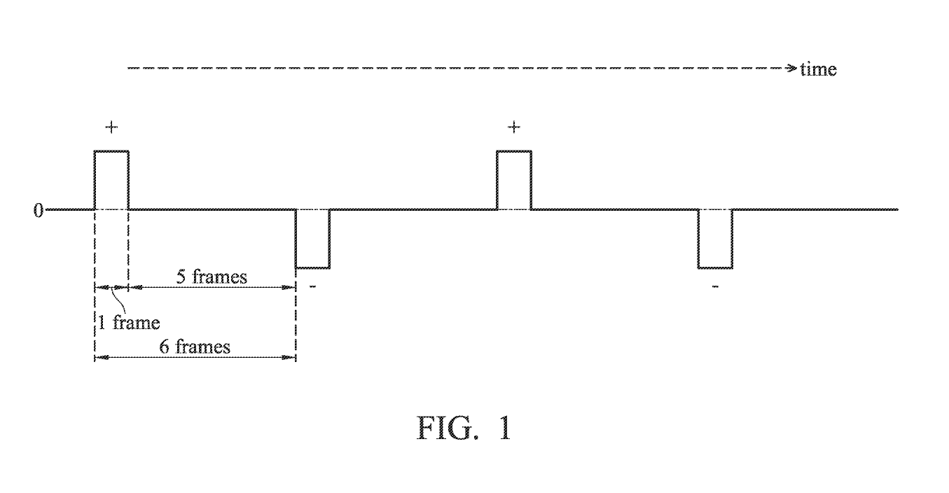

To introduce the invention, a conventional low frequency driving scheme is described in advance for reference. FIG. 1 is a diagram showing a conventional low frequency driving scheme with column inversion. When a liquid crystal display uses low frequency driving scheme to display a static image, an exemplary driving waveform output from a source driver of the liquid crystal display is shown in FIG. 1. According to the driving waveform, a pixel cell is refreshed every 6 frames (also called a refresh period), wherein the pixel cell is charged in the first frame (also called a charge period) and is not charged in the following five frames (also called a suspension period). The polarity of the charge pulse is inverted in each refresh period. Therefore, the liquid crystal display can save power when displaying a static image by lowering the driving frequency (in FIG. 1, the driving frequency is 10 Hz).

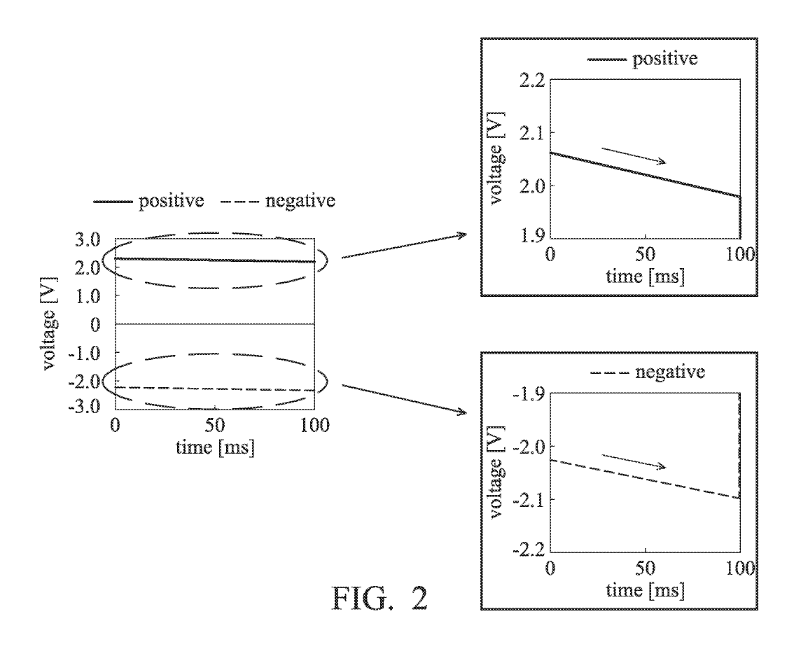

FIG. 2 is a diagram showing the pixel voltage change during the refresh period under the low frequency driving scheme shown in FIG. 1. When a display is driven at 60 frames per second, 100 ms is equal to 6 frames. Therefore, FIG. 2 shows the pixel voltage change during a refresh period shown in FIG. 1. Here, an n-channel TFT is connected to the pixel cell to control the timing when data is written into the pixel cell. During the refresh period, the n-channel TFT is applied with a negative voltage to hold the pixel voltage. However, the pixel voltage still decreases slowly due to leakage current flowing between the gate and the channel of the n-channel TFT. Therefore, after a rapid charge to a desired pixel voltage, the pixel cell continuously decreases its pixel voltage during the refresh period. As shown in FIG. 2, the positive pixel voltage and the negative pixel voltage both decrease during the refresh period. At the time 100 ms (the beginning of the next refresh period), the positive pixel voltage rapidly changes to negative and the negative pixel voltage rapidly changes to positive.

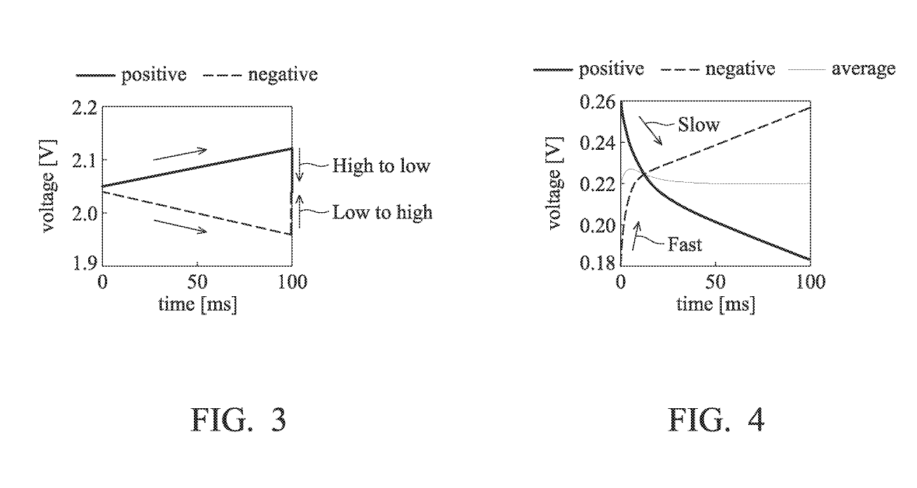

FIG. 2 shows only the pixel voltage change, but the orientation of the liquid crystal molecules are controlled by the voltage across the pixel cell rather than by the pixel voltage. Therefore, the voltage change across the pixel cell should be analyzed. The voltage across the pixel cell (also called an LC applied voltage V_{LC}) is the absolute value of the pixel voltage minus the common voltage. Thus, the pixel voltage change across the pixel cell can be easily obtained From FIG. 2. FIG. 3 is a diagram showing the voltage change across the pixel cell during the refresh period under the low frequency driving scheme shown in FIG. 1. As shown in FIG. 3, when the pixel voltage is positive, the LC applied voltage V_{LC} decreases slowly during the refresh period because of the leakage current and increases rapidly from low to high at time 100 ms because of the charge pulse. On the other hand, when the pixel voltage is negative, the LC applied voltage V_{LC} increases slowly during the refresh period because of the leakage current and decreases rapidly from high to low at time 100 ms because of the charge pulse.

Next, the light intensity of the pixel cell during the refresh period under the low frequency driving scheme shown in FIG. 1 is analyzed. FIG. 4 is a diagram showing the light intensity change during the refresh period under the low frequency driving scheme shown in FIG. 1. The light intensity of the pixel cell is controlled by the orientation of the liquid crystal molecules and the orientation of the liquid crystal molecules is controlled by the electric field due to the LC applied voltage V_{LC}. In this example, the light intensity becomes higher as the voltage increases and becomes lower as the voltage decrease. Therefore, when the pixel voltage is positive, the light intensity falls abruptly at the beginning of the refresh period due to the high-to-low pulse of the LC applied voltage V_{LC} as shown in FIG. 3. Then the falling speed of the light intensity becomes slower due to the gradual decrease in the LC applied voltage V_{LC}. On the other hand, when the pixel voltage is negative, the light intensity rises abruptly at the beginning of the refresh period due to the low-to-high pulse of the LC applied voltage V_{LC} as shown in FIG. 3. Then the rising speed of the light intensity becomes slower due to the gradual increase in the LC applied voltage V_{LC}.

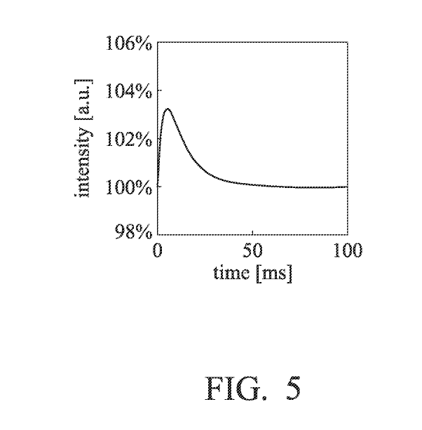

However, the light intensity curves under the positive pixel voltage and the negative voltage are not symmetric, because the response characteristic of liquid crystal molecules to the LC applied voltage V_{LC} is not linear. Especially, the low-to-high pulse of the LC applied voltage V_{LC} changes the light intensity faster than the high-to-low pulse of the LC applied voltage V_{LC}. Thus, an average curve of the light intensity curves under the positive pixel voltage and the negative pixel voltage has a ripple as shown in FIG. 4. The average curve is then normalized as shown in FIG. 5. From FIG. 5, it can be seen that the ripple brings about a 3% change of the light intensity, and this change causes a visible flicker.

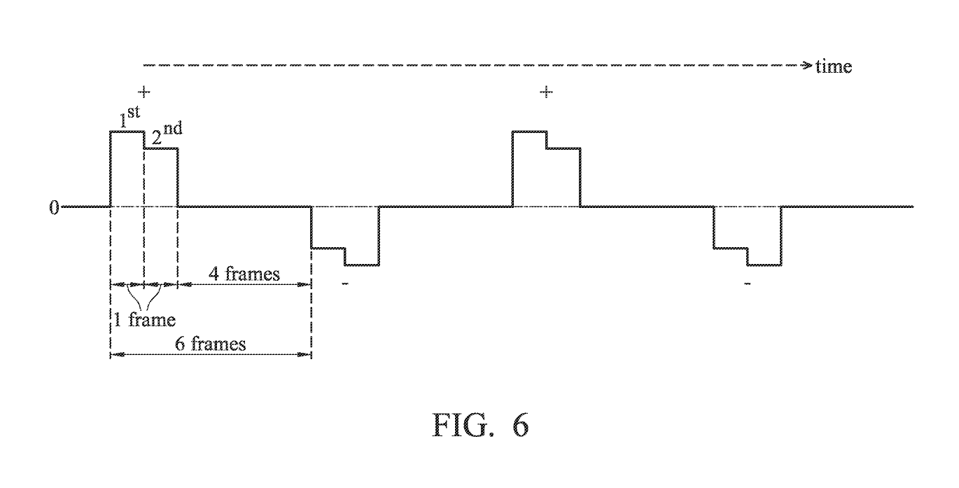

An embodiment of the invention that can effectively improve the aforementioned problem is described below. The invention changes the number of charging of the pixel voltage during the refresh period. FIG. 6 is a diagram showing a low frequency driving scheme with column inversion in accordance with an embodiment of the invention. In FIG. 6, a pixel cell is still refreshed every 6 frames. Thus, the refresh period is the same as the conventional low frequency driving scheme. However, there are two charge periods in each refresh period. As shown in FIG. 6, the pixel is charged by a non-target voltage in the first frame and then charged by a target voltage in the second frame. After that, the pixel is not charged until the next refresh period. The polarity of the charge pulses are inverted in each refresh period. Note that the non-target voltage is determined according to the target voltage, and each target voltage corresponds to a distinct non-target voltage. In addition, the non-target voltage could be greater than the target voltage or smaller than the target voltage, but the non-target voltage is never equal to the target voltage.

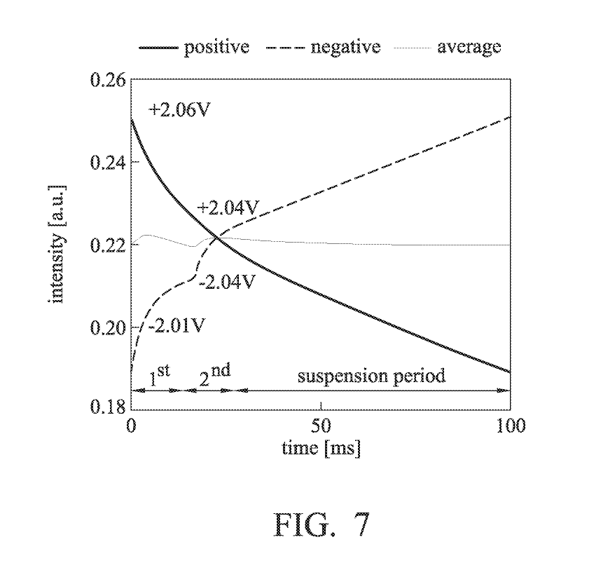

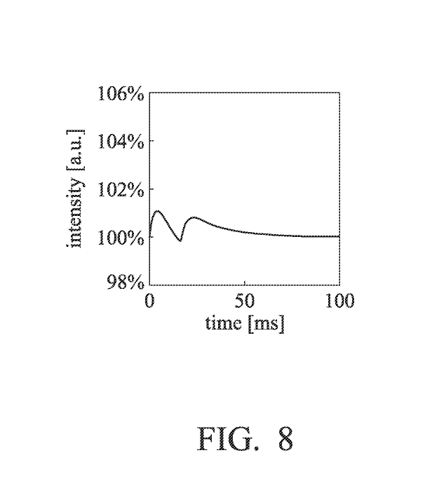

FIG. 7 is a diagram showing the pixel voltage change during the refresh period under the low frequency driving scheme shown in FIG. 6. Under the two-time charge scheme of the embodiment, the light intensity curve under the positive pixel voltage and the light intensity curve under the negative pixel voltage can be adjusted to be almost symmetric to each other. As shown in FIG. 7, the positive target voltage is +2.04V and the negative target voltage is −2.04V. The non-target voltage for the positive target voltage is set to +2.06V and the non-target voltage for the negative target voltage is set to −2.01V. By setting non-target voltages with different amplitudes for the positive target voltage and the negative target voltage respectively, the light intensity curve under the negative pixel voltage and the light intensity curve under the positive pixel voltage are adjusted to a different extent. In this embodiment, the slope of the light intensity curve under the negative pixel voltage is alleviated at the first two frames more than the slope of the light intensity curve under the positive pixel voltage. Consequently, the light intensity curve under the positive pixel voltage and the light intensity curve under the negative pixel voltage are close to symmetric, so that the average curve of the two light intensity curves has a smaller ripple than the average curve generated under the conventional driving scheme. When the average curve of the embodiment is normalized, as shown in FIG. 8, the ripple brings a mere 1% change of light intensity, and this change causes a flicker at an invisible level.

According to the embodiment, when the liquid crystal display is displaying a static image by low frequency driving scheme of the invention, visible flicker is reduced and the image quality is improved. The low frequency driving scheme of the invention is especially applicable to low-middle gray leveled static images. Because the flicker is more serious in low to middle gray levels, the improvement is more obvious.

The above embodiment discloses a two-time charge scheme, but the number of charging of the pixel voltage during each refresh period is not limited to 2. There can be more than one frame for charging non-target voltages before the frame for charging a target voltage. Moreover, the low frequency driving scheme of the invention is performed only when the polarity of the charge voltage is inverted. The inversion type of the liquid crystal display is not limited to column inversion, and the low frequency driving scheme of the invention is also applicable to dot inversion, row inversion, frame inversion etc.

In the driving scheme of the invention, a pixel cell is charged at least two times during one refresh period. The target voltage is the gray level voltage which is applied to the pixel cell to output a gray level to be displayed. The non-target voltage is different from the gray level voltage. The low frequency driving scheme of the invention may be considered a kind of overdrive scheme, but there are several specific differences between them.

First and foremost, the overdrive scheme is used to shorten the response time of the liquid crystal molecules, so the amplitude of the overdrive voltage is always greater than the target voltage. However, in the driving scheme of the invention, as described in the previous paragraph, the amplitude of the non-target voltage may be greater or smaller than the target voltage. As shown in FIG. 7, the amplitude of non-target voltage (2.06V) for the positive target voltage is larger than the amplitude of that target voltage (2.04V), and the amplitude of non-target voltage (2.01V) for the negative target voltage is smaller than the amplitude of that target voltage (2.04V).

Moreover, since the purpose of the overdrive scheme is to shorten the response time of the liquid crystal molecules, the overcharge period and the normal charge period are generally shorter than 1 frame. However, the driving scheme of the invention uses at least one frame for charging non-target voltage and one frame for charging target voltage. Thus, the driving scheme of the invention has a longer charge period than the overdrive scheme.

Last but not least, the low frequency driving scheme of the invention is only applied when the liquid crystal display is displaying a static image. When a static image is displayed, the input data for each pixel is not changed so a gray level is refreshed to the same gray level. Because the gray level is not changed, the orientation of the liquid crystal molecules is also not changed. Thus, under the overdrive scheme, it is not necessary to shorten the response time of the liquid crystal molecules, so the overcharge voltage is equal to the target voltage when the gray level is not changed. On the other hand, in the low frequency driving scheme of the invention, the non-target voltage is always different from the target voltage even though the gray level is not changed.

Given the above points, the driving scheme of the invention is substantially different from an overdrive scheme.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An active matrix liquid crystal display, comprising:
a plurality of pixel cells, each of which is formed by a pair of electrodes sandwiching a liquid crystal layer,
wherein when the active matrix liquid crystal display is displaying a static image, the pixel cell is refreshed through a first period, a second period, and a third period in sequence,
wherein in the first period, the pixel cell is charged by at least a non-target voltage;
in the second period, the pixel cell is charged by a target voltage; and
in the third period, the pixel cell is not charged until the next first period.

2. The active matrix liquid crystal display as claimed in claim 1, wherein the first period lasts for at least one frame, the second period lasts for a frame, and the third period lasts for a plurality of frames.

3. The active matrix liquid crystal display as claimed in claim 1, wherein the non-target voltage is determined according to the target voltage, and each target voltage corresponds to a distinct non-target voltage.

4. The active matrix liquid crystal display as claimed in claim 1, wherein the target voltages in any two adjacent second periods have opposite polarities.

5. The active matrix liquid crystal display as claimed in claim 1, wherein the target voltage is a gray level voltage which is applied to the pixel cell to output a gray level to be displayed.

6. A driving method for an active matrix liquid crystal display comprising a plurality of pixel cells, each of which is formed by a pair of electrodes sandwiching a liquid crystal layer, the driving method comprising:
charging the pixel cell with at least a non-target voltage in a first period;
charging the pixel cell with a target voltage in a second period following the first period; and
stopping the charging of the pixel cell in a third period following the second period,
wherein the first to third periods are repeated to continuously refresh a static image.

7. The driving method as claimed in claim 6, wherein the first period lasts for at least one frame, the second period lasts for a frame, and the third period lasts for a plurality of frames.

8. The driving method as claimed in claim 6, wherein the non-target voltage is determined according to the target voltage, and each target voltage corresponds to a distinct non-target voltage.

9. The driving method as claimed in claim 6, wherein the target voltages in any two adjacent second periods have opposite polarities.

10. The driving method as claimed in claim 6, wherein the target voltage is a gray level voltage which is applied to the pixel cell to output a desired level to be displayed.
